(19) United States
(12) Patent Application Publication
(10) Pub. No.: US 2024/0389063 A1
(43) Pub. Date: Nov. 21, 2024

(54) WIRELESS COMMUNICATION WITH RESOURCE CONFIGURATION FOR POSITIONING

(71) Applicant: ZTE Corporation, Shenzhen (CN)

(72) Inventors: Jiajun CHEN, Shenzhen (CN); Dapeng LI, Shenzhen (CN); Yin GAO, Shenzhen (CN)

(73) Assignee: ZTE Corporation, Shenzhen (CN)

(21) Appl. No.: 18/779,277

(22) Filed: Jul. 22, 2024

Related U.S. Application Data
(63) Continuation of application No. PCT/CN2022/112555, filed on Aug. 15, 2022.

(51) Int. Cl. H04W 64/00; H04B 7/06; H04L 5/00; H04W 92/18

(52) U.S. Cl. CPC H04W 64/00; H04B 7/06968; H04L 5/0051; H04W 92/18

(57) ABSTRACT

In wireless communications, accuracy in positioning methods may be important. Sidelink positioning communications with sidelink positioning reference signal may be used. Including sidelink positioning information in those communications may improve the positioning. The sidelink positioning information may include a sidelink positioning reference signal configuration and/or a sidelink communication resource. The communications may be with a location management function and/or between a basestation centralized unit and a basestation distributed unit. Further, the communications may be through transmission/reception point communications or through sidelink positioning reference signal communications.

### TECHNICAL FIELD

This document is directed generally to wireless communications. More specifically, in a mobile device communications system, there may be improved positioning for sidelink communications by include sidelink positioning information in the communications.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document relates to methods, systems, and devices for wireless communications with improved accuracy in positioning. Sidelink (SL) positioning communications with a sidelink positioning reference signal (SL-PRS) may be used. Including SL positioning information in those communications may improve the positioning. The SL positioning information may include a SL-PRS configuration and/or a SL communication resource. The communications may be with a location management function (LMF) and/or between a basestation centralized unit (CU) and a basestation distributed unit (DU). Further, the communications may be through transmission/reception point (TRP) communications or through SL-PRS communications.

In one embodiment, a method for wireless communication includes receiving a Transmission/Reception Point (TRP) request message with a request for sidelink configuration information; and transmitting a TRP response message with the sidelink configuration information. The receiving is by a basestation from a location management function (LMF) and the transmitting is from the basestation to the LMF. The receiving is by a basestation distributed unit (DU) from a basestation centralized unit (CU) and the transmitting is from the basestation DU to the basestation CU. The sidelink configuration information comprises a sidelink positioning reference signal (SL-PRS) configuration or a sidelink resource configuration. The SL-PRS configuration comprises at least one of a SL-PRS Resource Set ID, a Subcarrier spacing, a SL-PRS bandwidth, an absolute radio frequency channel number (ARFCN), a Comb Size, a Resource Set Periodicity, a Resource Repetition Factor, a Resource Time Gap, a Resource Number of Symbols, a SL-PRS Muting Pattern, a SL-PRS Resource Transmit Power, a SL-PRS Resource ID, a Quasi Colocation (QCL) Information per SL-PRS, a Resource Slot Offset, or a Resource Symbol Offset. The sidelink resource configuration comprises at least one of a resource block (RB) number, a RB sub channel, a subchannel size, a time resource, a time offset, or a synchronization signal block (SSB) priority. The TRP request message includes a TRP type information element that includes a request for at least one of the sidelink positioning reference signal (SL-PRS) configuration or the sidelink resource configuration. The TRP response message comprises TRP information that includes at least one of the sidelink positioning reference signal (SL-PRS) configuration or the sidelink resource configuration. The method further includes transmitting a TRP fail message when the sidelink configuration information is not available for transmission.

In one embodiment, a method for wireless communication includes sending a Transmission/Reception Point (TRP) request message with a request for sidelink configuration information; and receiving a TRP response message with the sidelink configuration information. The sending is by a location management function (LMF) to a basestation, and the receiving is at the LMF from the basestation. The sending is by a basestation centralized unit (CU) to a basestation distributed unit (DU), and the receiving is at the basestation CU from the basestation DU. The sidelink configuration information comprises a sidelink positioning reference signal (SL-PRS) configuration or a sidelink resource configuration. The SL-PRS configuration comprises at least one of a SL-PRS Resource Set ID, a Subcarrier spacing, a SL-PRS bandwidth, an absolute radio frequency channel number (ARFCN), a Comb Size, a Resource Set Periodicity, a Resource Repetition Factor, a Resource Time Gap, a Resource Number of Symbols, a SL-PRS Muting Pattern, a SL-PRS Resource Transmit Power, a SL-PRS Resource ID, a Quasi Colocation (QCL) Information per SL-PRS, a Resource Slot Offset, or a Resource Symbol Offset. The sidelink resource configuration comprises at least one of a resource block (RB) number, a RB sub channel, a subchannel size, a time resource, a time offset, or a synchronization signal block (SSB) priority. The TRP request message includes a TRP type information element that includes a request for at least one of the sidelink positioning reference signal (SL-PRS) configuration or the sidelink resource configuration. The TRP response message comprises TRP information that includes at least one of the sidelink positioning reference signal (SL-PRS) configuration or the sidelink resource configuration. The method further includes receiving a TRP fail message when the sidelink configuration information is not available for transmission.

In one embodiment, a method for wireless communication includes receiving a Sidelink Positioning Reference Signal (SL-PRS) request message with a sidelink configuration information; and transmitting a SL-PRS response message with the sidelink configuration information. The receiving is by a basestation from a location management function (LMF) and the transmitting is from the basestation to the LMF. The receiving is by a basestation distributed unit (DU) from a basestation centralized unit (CU) and the transmitting is from the basestation DU to the basestation CU. The sidelink configuration information comprises a SL-PRS configuration or a sidelink resource configuration. The SL-PRS configuration comprises at least one of a SL-PRS Resource Set ID, a Subcarrier spacing, a SL-PRS bandwidth, an absolute radio frequency channel number (ARFCN), a Comb Size, a Resource Set Periodicity, a Resource Repetition Factor, a Resource Time Gap, a Resource Number of Symbols, a SL-PRS Muting Pattern, a SL-PRS Resource Transmit Power, a SL-PRS Resource ID, a Quasi Colocation (QCL) Information per SL-PRS, a Resource Slot Offset, or a Resource Symbol Offset. The sidelink resource configuration comprises at least one of a resource block (RB) number, a RB sub channel, a subchannel size, a time resource, a time offset, or a synchronization signal block (SSB) priority. The SL-PRS request message includes a SL-PRS information element (IE) that includes a request for at least one of the sidelink positioning reference signal (SL-PRS) configuration or the sidelink resource configuration. The SL-PRS response message comprises a SL-PRS information element (IE) that includes at least one of the sidelink positioning reference signal (SL-PRS) configuration or the sidelink resource configuration. The method further includes transmitting a SL-PRS fail message when the sidelink configuration information is not available for transmission.

In one embodiment, a method for wireless communication includes sending a Sidelink Positioning Reference Signal (SL-PRS) request message with a request for sidelink configuration information; and receiving a SL-PRS response message with the sidelink configuration information. The sending is by a location management function (LMF) to a basestation, and the receiving is at the LMF from the basestation. The sending is by a basestation centralized unit (CU) to a basestation distributed unit (DU), and the receiving is at the basestation CU from the basestation DU. The sidelink configuration information comprises a sidelink positioning reference signal (SL-PRS) configuration or a sidelink resource configuration. The SL-PRS configuration comprises at least one of a SL-PRS Resource Set ID, a Subcarrier spacing, a SL-PRS bandwidth, an absolute radio frequency channel number (ARFCN), a Comb Size, a Resource Set Periodicity, a Resource Repetition Factor, a Resource Time Gap, a Resource Number of Symbols, a SL-PRS Muting Pattern, a SL-PRS Resource Transmit Power, a SL-PRS Resource ID, a Quasi Colocation (QCL) Information per SL-PRS, a Resource Slot Offset, or a Resource Symbol Offset. The sidelink resource configuration comprises at least one of a resource block (RB) number, a RB sub channel, a subchannel size, a time resource, a time offset, or a synchronization signal block (SSB) priority. The SL-PRS request message includes a SL-PRS information element (IE) that includes a request for at least one of the sidelink positioning reference signal (SL-PRS) configuration or the sidelink resource configuration. The SL-PRS response message comprises a SL-PRS information element (IE) that includes at least one of the sidelink positioning reference signal (SL-PRS) configuration or the sidelink resource configuration. The method further includes receiving a SL-PRS fail message when the sidelink configuration information is not available for transmission.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows a network architecture of a basestation Central Unit (CU) and basestation Distributed Unit (DU).

FIG. 4 shows a network architecture with several basestation Central Units (CU) and basestation Distributed Units (DU).

FIG. 5 shows an embodiment of user equipment (UE) intra-DU mobility.

FIG. 6 shows an embodiment of user equipment (UE) intra-CU and inter-DU mobility.

FIG. 7 shows an embodiment of user equipment (UE) inter-CU mobility.

FIG. 8 shows an example of sidelink positioning coverage scenarios.

FIG. 9 shows an example of a positioning procedure.

FIG. 10 shows a TRP information exchange procedure.

FIG. 11 shows a SL-PRS Positioning Configuration procedure.

FIG. 12 shows another TRP information exchange procedure. FIG. 13 shows another SL-PRS Positioning Configuration procedure.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

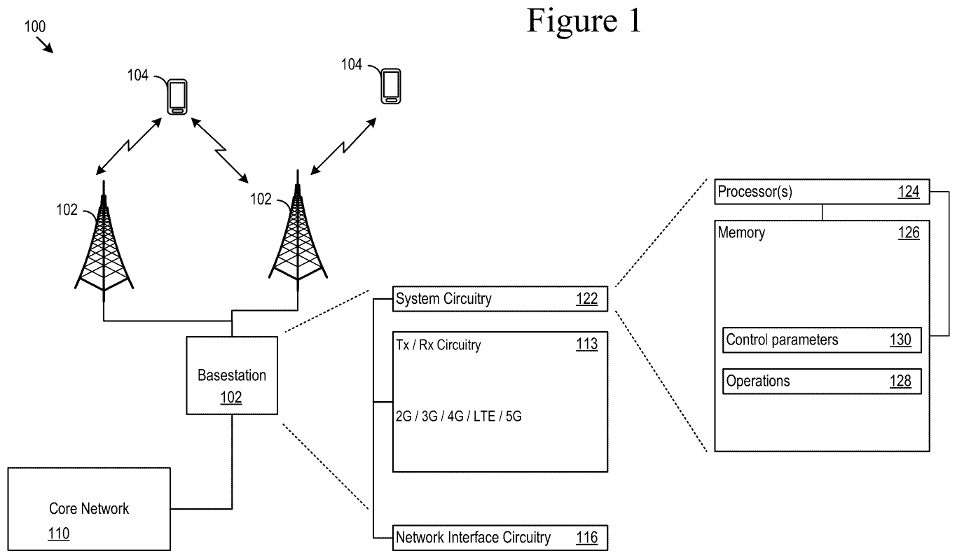

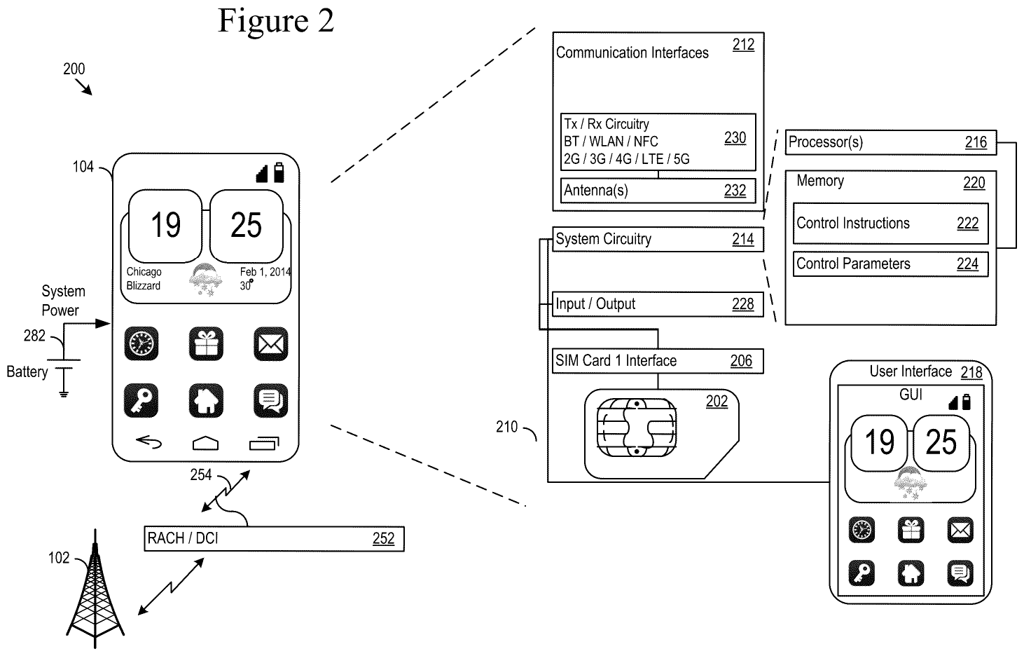

Radio resource control (“RRC”) is a protocol layer between UE and the basestation at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. The RACH scheme is merely one example of a protocol scheme for communications and other examples, including but not limited to CG, are possible. FIGS. 1-2 show example radio access network (“RAN”) nodes (e.g. basestations) and user equipment and messaging environments. CG may be used to reduce the waste of periodically allocated resources by enabling multiple devices to share periodic resources. The basestation or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access. The communications described herein may be specific to sidelink communications, which may also be referred to as device to device (“D2D”) communications.

Sidelink communications may relieve the burden of the cellular network, power consumption of user equipment (“UE”) can be reduced, data rates can be increased, and robustness of network infrastructures can be improved, all of which can fulfill the demands of high data rate services and the proximity services. The relay communications or D2D technology may also be referred to as a proximity service (“ProSe”) or sidelink communications. An interface between equipment may be known as or referred to as a PC5 interface. PC5 may be where the UE directly communicates with another UE over a direct channel without the basestation. In some embodiments, the sidelink-based relay communication may be applied to indoor relay communication, smart farming, smart factory and public safety services. Sidelink may work depending on the positioning of each of the devices. For example, two user equipment (UE) devices must be in range to engage in sidelink communications. The positioning may also be referred to as ranging, and may include relative positioning and absolute positioning. Based on the positioning, the bandwidth requirements may be different to meet accuracy requirements.

The UE can perform positioning with the network via a UU interface by sending a sounding reference signal (SRS) and receiving a positioning reference signal (PRS) signal. When the UE is out of the coverage area of the network (NW), or when the UE is in a coverage area of the NW but has a low channel quality, then the UE may need to acquire its precise location. A transfer between UEs may be from an initiating UE and a transfer UE. The initiating UE may be the UE wants to acquire its own location by sidelink positioning, or may be the UE receiving the location request from the network. The target UE(s) may be the UE(s) that are initiating UE transmissions of Sidelink Positioning Reference Signal (SL-PRS) to/receives SL-PRS. The initiating UE and the target UE may form a UE pair. In order to perform SL positioning, the target UE should know its precise location. The initiating UE may be referred to as a target UE and when the target UE corresponds to the initiating UE it may be referred to as a peer UE or associated peer UE. The target UE may be the UE that wants to acquire its own location by sidelink positioning or the UE receiving the location request from the network. The peer UE(s) are the UE(s) that initiate the UE transmission of SL-PRS or receives the SL-PRS. The target UE and associated peer UE may form a UE pair. Peer UE may also be referred to as anchor UE and to perform SL positioning, peer UE may need to know its precise location. In the example embodiments, the initiating UE is shown up with the target UE, and the target UE is shown up with peer UE. The embodiments may be applicable when the UE is in any coverage, including 1) when both UEs in the UE pair are in coverage/partial coverage of network; 2) when one of the UE in the UE pair is in coverage/partial coverage, while the other one is out of coverage; or 3) both UEs in the UE pair are out of coverage.

Sidelink communications may be used for positioning between devices. The sidelink based communications may be between equipment (“UE”) and/or with other network nodes, such as a basestation. The sidelink positioning information may be used for location determination. In one example, the UEs may be cellular vehicle to everything (CV2X or C-V2X) or vehicle to everything (V2X) UEs. The sidelink technology can be applied to V2X UEs to perform positioning. Sidelink technology can specify the communication between V2X UEs for the transmission of control signaling and service data via a PC5 interface. The PC5 interface may include PC5 signaling, or PC5 RRC signaling to specify a configuration for a unicast link or resource allocation. Signaling transfer methods or procedures can specify a high layer structure for sidelink positioning. Sidelink may include the direct communication over PC5. Vehicle to vehicle (V2V) communications may be based on D2D communications. The D2D interface may be designated as PC5 and is also known as sidelink at the physical layer. The PC5 interface has been enhanced for vehicular use cases, including addressing high speed and high density (number of nodes). The direct communication between a vehicle and other devices (V2V, V21) may use the PC5 interface. PC5 may refer to a reference point the UE communicates with a node over a direct channel without the basestation.

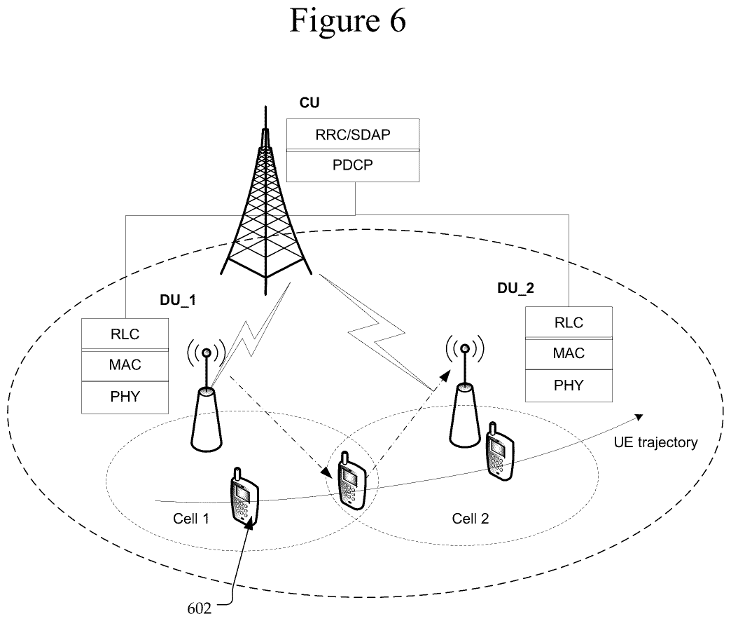

As described below with respect to at least FIGS. 1-8, a network provider may include a number of network nodes (i.e. basestations) for providing network access to a user equipment (“UE”) device. The network nodes are referred to as basestations in some embodiments. FIGS. 5-7 illustrate cell mobility in which the UE device moves between cells. Control signaling may be used to facilitate this mobility.

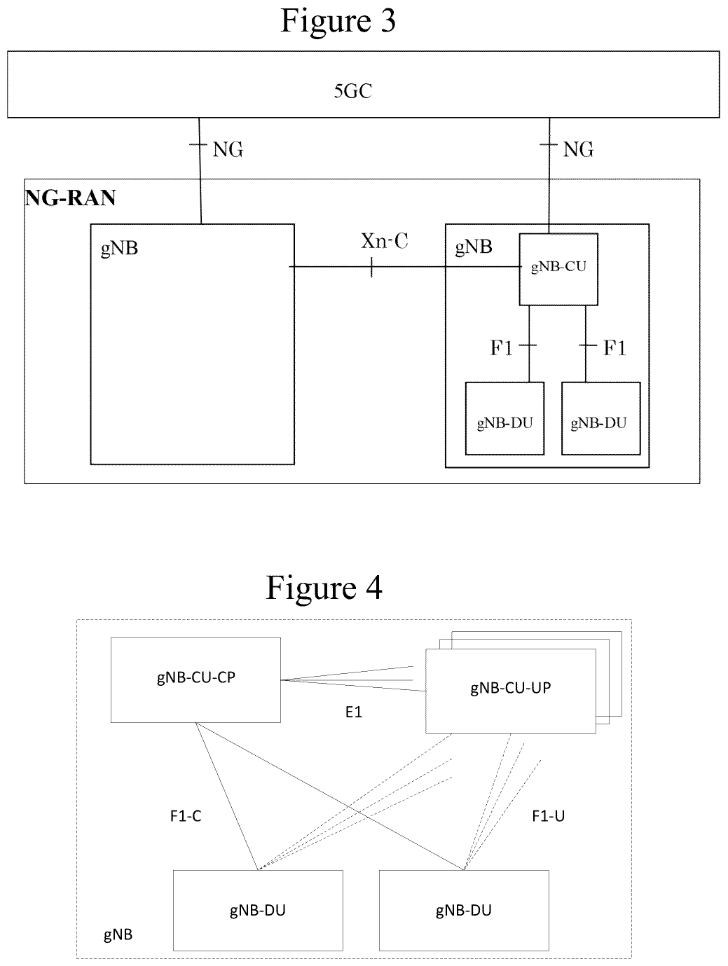

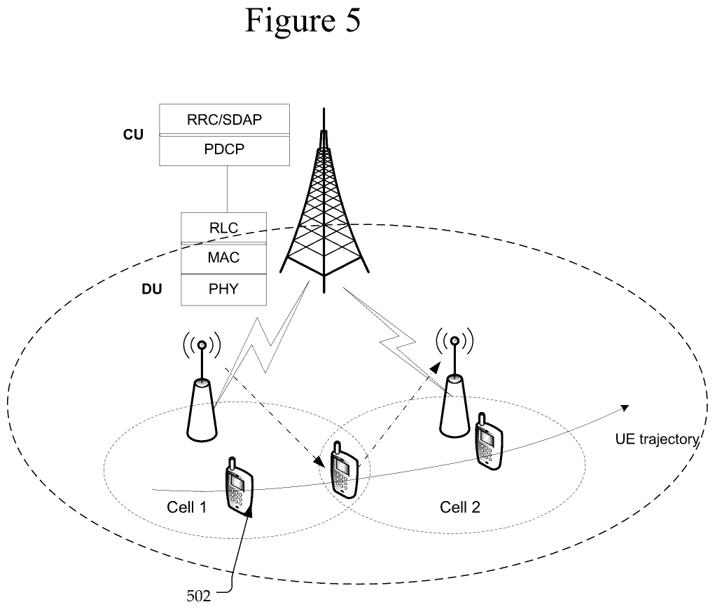

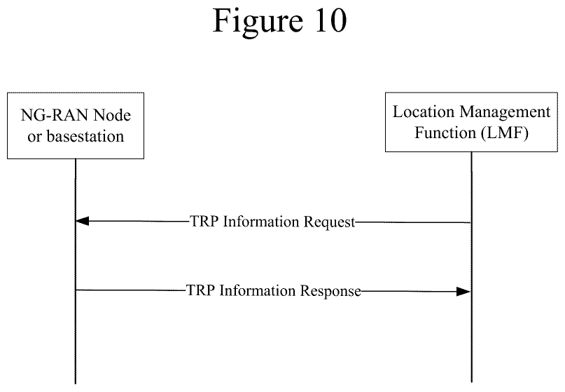

Sidelink (SL) positioning information (e.g. sidelink positioning reference signal (SL-PRS) configuration or SL resource configuration described herein) may be communicated in the embodiments described herein. FIGS. 5-8 below show exemplary embodiments in which sidelink communications may be utilized. FIGS. 1-2 show example basestations and user equipment and messaging environments which may be applicable to the sidelink communications as described below. The description of UEs and the network above may apply to each of the embodiments. FIGS. 3-4 show an example network system for basestation centralized unit (CU) and a basestation distributed unit (DU), which may communicate the SL positioning information. Specifically, FIGS. 3-4 illustrate a CU split from a DU, while FIG. 3 shows a network architecture of a basestation CU and basestation DU. FIGS. 9-12 show example communications with the SL positioning information.

FIG. 1 shows an example basestation 102. The basestation may also be referred to as a wireless network node and may be the network nodes (e.g. master node (“MN”), secondary node (“SN”), and the source/target nodes) shown in FIGS. 3A-7B. The basestation 102 may be further identified to as a nodeB (NB, e.g., an eNB, gNB, xNB, etc.) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA) +, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC. The signaling connection between AMF/SMF and the master node (“MN”) may be a Next Generation-Control Plane (“NG-C”)/MN interface. The signaling connection between MN and SN may an Xn-Control Plane (“Xn-C”) interface. The signaling connection between MN and UE is a Uu-Control Plane (“Uu-C”) RRC interface. All these connections manage the configuration and operation of MR-DC. The user plane connection between User Plane Function (“UPF”) and MN may be NG-U (MN) interface instance.

FIG. 3 shows a network architecture of a basestation Central Unit (CU) and basestation Distributed Unit (DU). FIG. 3 illustrates basestations (labeled as “gNB”) that communicate with an overall network (labeled (“5GC”). Basestations can communicate with one another via a control plane interface (“Xn-C”). One basestation is shown as having one CU that is connected to two DUs via an FI interface. This is merely one example of an arrangement of a basestation. In some embodiments, there may be one or any number of DUs connected with a single CU.

The basestation can be divided into two physical entities named Centralized Unit (“CU”) and Distributed Unit (“DU”). Generally, the CU may provide support for the higher layers of the protocol stack such as SDAP, PDCP and RRC while the DU provides support for the lower layers of the protocol stack such as RLC, MAC and Physical layer. The CU may include operations for a transfer of user data, mobility control, radio access network sharing, session management, etc., except those functions allocated exclusively to the DU. The DU(s) are logical node(s) with a subset of the basestation functions, and may be controlled by the CU.

The CU may be a logical node hosting RRC, SDAP and PDCP protocols of the basestation or RRC and PDCP protocols of the basestation that controls the operation of one or more DUs. The DU may be a logical node hosting RLC, MAC and PHY layers of the basestation, and its operation may be at least partly controlled by the CU. A single DU may support one or multiple cells. However, each cell is only supported by a single DU. Each basestation may support many cells. As described in the embodiments herein, the cell mobility between cells may be from different CUs or DUs or may be internal to the CU and/or the DU.

The inter-cell mobility described herein may occur in a number of different examples. There may be intra-DU mobility where a UE changes cells within a single DU. In another mobility embodiment, there may be intra-CU and inter-DU mobility where a UE changes cells between different DUs but within a single CU. In another mobility embodiment, there may be inter-CU mobility where a UE changes cells between different CUs.

FIG. 4 shows a network architecture with several basestation Central Units (CU) and basestation Distributed Units (DU). In one embodiment, the architecture for separation of a basestation CU-CP and basestation CU-UP is shown in FIG. 4. This may be used when there is a failure of basestation CU. In some embodiments, a basestation may include a basestation CU-CP, multiple basestation CU-UPs and multiple basestation DUs. The basestation CU-CP may be connected to the basestation DU through the F1-C interface. In some embodiments, the basestation CU-UP may be connected to the basestation DU through the F1-U interface. In some embodiments, the basestation CU-UP may be connected to the basestation CU-CP through the E1 interface. In some embodiments, the one basestation DU may be connected to only one basestation CU-CP. In some embodiments, one basestation CU-UP is connected to only one basestation CU-CP. For resiliency, a basestation DU and/or a basestation CU-UP may be connected to multiple basestation CU-CPs. In some embodiments, the backup, which may be referred to as the new basestation CU-CP may be located far from the original/initial/first basestation CU-CP.

Sidelink (SL) communication is further described with respect to FIGS. 5-8 below. Sidelink communication may also be referred to as sidelink messaging, sidelink relay, relay communications, or device to device (“D2D”) communication/messaging. There may be communication between devices, such as multiple user equipment (UE) devices. The sidelink communications may further include a send, a receive, a broadcast, a unicast, a request, a response, a forward, an exchange or a groupcast.

The sidelink information or the positioning information may include a sidelink positioning reference signal (SL-PRS) configuration. The SL-PRS configuration may be indicated in control signaling, in a control channel, in other channel(s), or in a Radio Resource Control (RRC) parameter. The control signaling may include sidelink control information (SCI), downlink control information (DCI), Medium Access Control (MAC) Control Elements (MAC CE), Non Access Stratum (NAS), or system information blocks (SIB). The control channel includes at least one of a physical sidelink control channel (PSCCH), a physical downlink control channel (PDCCH), or a physical uplink control channel (PUCCH). The other channel(s) include at least one of a physical sidelink shared channel (PSSCH), a physical downlink shared channel (PDSCH), a physical uplink shared channel (PUSCH), a Physical Broadcast Channel (PBCH), a Physical Sidelink Feedback Channel (PSFCH), or a Physical Sidelink Broadcast Channel (PSBCH).

The sidelink channel includes at least one of a physical sidelink shared channel (PSSCH), a physical sidelink shared channel (PSSCH), a Physical Sidelink Feedback Channel (PSFCH), or a Physical Sidelink Broadcast Channel (PSBCH). A unit of the frequency resource of SL-PRS comprises at least one of a Physical Resource block (PRB), a sub-channel, or a Resource element (RE). A size of the SL-PRS resource in the time domain comprise at least one of a number of symbol(s) per SL-PRS Resource, a number of symbol(s) a SL-PRS Resource, a number of symbol(s) per SL-PRS configuration, or a number of symbol(s) a SL-PRS configuration. The SL-PRS Resource or the SL-PRS configuration comprise at least one of a number of symbol(s) per SL-PRS Resource within a slot, a number of symbol(s) per SL-PRS configuration within a slot, a number of symbol(s) a SL-PRS Resource within a slot, or a number of symbol(s) a SL-PRS configuration within a slot. The reference point or the location of the point A comprises at least one of a positioning a frequency layer, a BWP, or a carrier frequency. The reference point or the location of the point A is a parameter provided by a high layer or SCI. The reference point or the location of the point A is associated with at least one of the lowest resource block (RB) index of a sidelink bandwidth part (SL BWP), a lowest RB index of the subchannel with a lowest index in the resource pool, a lowest RB index of a SL carrier frequency, a lowest subchannel index in the resource pool, the lowest subchannel index of a SL BWP, or a lowest subchannel index of a SL carrier frequency. The SL-PRS hop ID refers to a Scrambling ID for sequence hopping of the sidelink positioning reference signal (SL-PRS) configuration. The SL-PRS hop ID is used for a resource pool, a BWP, or a carrier frequency. The combination of the size of the SL-PRS resource in the time domain and the comb size is at least one of {2, 2}, {4, 2}, {6, 2}, {12, 2}, {4, 4}, {12, 4}, {6, 6}, {12, 6}, and {12, 12}. A value of the SL-PRS sequence ID is associated with a value of a user equipment identification (UEID). The SL-PRS sequence ID is used to initialize a value in a pseudo random generator for generation of the SL-PRS sequence for transmission on a SL-PRS Resource. The sidelink information, the positioning information, or a sidelink positioning reference signal (SL-PRS) configuration is configured by at least one of: a high layer parameter, a sidelink control information (SCI), or a NAS parameter. The communication device comprises a user equipment (UE), a network node, a basestation, a local sever, a Transmission/Reception Point (TRP) or a Location Management Function (LMF). The SL-PRS period(s) is associated with the time resource used in a sidelink resource pool, a BWP or a carrier frequency.

In some embodiments, such as during emergency situations (e.g. earthquake), the cellular network may operate abnormally or a sidelink communication range of the network may need to be extended. Thus, the relay communications may be designed for allowing multiple UEs to communicate with each other via the relay UE. Although not shown, there may be multiple UEs in a relay communication chain, or a relay UE may have multiple remote UEs. The interface between the UE and BS during relay communications may be referred to as the Uu interface.

In some embodiments, the sidelink communications may be between user equipment (UE), a network node, a basestation, a local sever, a Transmission/Reception Point (TRP), or a Location Management Function (LMF). The UE 104 described above with respect to FIGS. 1-2 may be a vehicle UE, pedestrian UE, or a road side unit (RSU) with or without known location. The UE may include a positioning reference unit (PRU) with or without a known location. The UE may be any UE that supports vehicle to everything (V2X) service and/or sidelink communication. Although illustrated as PC5 signaling, the sidelink communications between the UE and the node may include other types of signaling, such as PC5-RRC signaling, sidelink control information (SCI), new logical layer signaling, or media access control element (MAC-CE).

The node communicating with the UE in sidelink communication may include another UE, such as a different UE 104. Alternatively, the node may be a network node. The network node is part of the network and may include a V2X application server or a transmission/reception point (TRP). In one embodiment, location management function (LMF) may be used to improve positioning. LMF may receive measurements/assistance information from the basestation and the UE. This may be transmitted via the access and mobility management function (AMF) to calculate the UE position. The LMF may configure the UE via AMF, while the basestation may configure the UE using radio resource control (RRC) protocol. Example network devices for the nodes in sidelink communication with UE may include a basestation, which may be an example of a next-generation radio access node (NG-RAN). The network node may further include a gNode B (gnB) or a next generation eNodeB (ng-enB). The network may further include a core network, a Transmission/Reception Point (TRP), or a Location Management Function (LMF).

Location management function (LMF) may be used to improve positioning. LMF may receive measurements/assistance information from the basestation and the UE. This may be transmitted via the access and mobility management function (AMF) to calculate the UE position. The LMF may configure the UE via AMF, while the basestation may configure the UE using radio resource control (RRC) protocol.

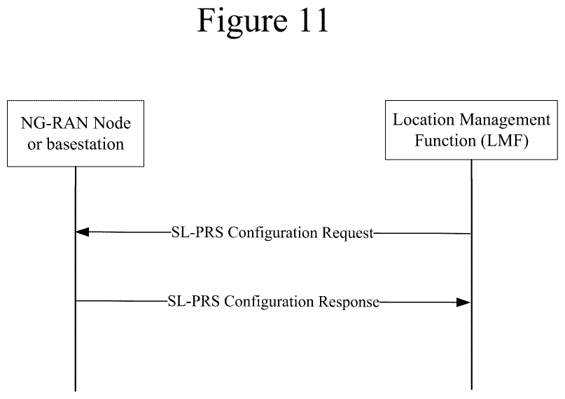

The signaling may include PC5 signaling, or other types of sidelink and/or D2D communications, including V2X communications. The signaling may include location information, position information, position configuration information, location/position data, and/or measurement reports. The position information is further described below. There may be a request and response for each of the signaling as further described with respect to FIGS. 10-13.

FIG. 5 shows an embodiment of user equipment (UE) intra-DU mobility. The basestation may include a CU and at least one DU. In this embodiment, there is a single DU shown that has multiple cells. Both Cell 1 and Cell 2 are from the single DU. In this example, the UE 502 can move from Cell 1 to Cell 2 and is depicted in FIG. 4 with a UE trajectory from Cell 1 to Cell 2. The mobility from cells may occur when the UE 402 is in a position between the two cells and making its way to the third position within Cell 2. This is intra-DU mobility because the UE is moving cells within a single DU.

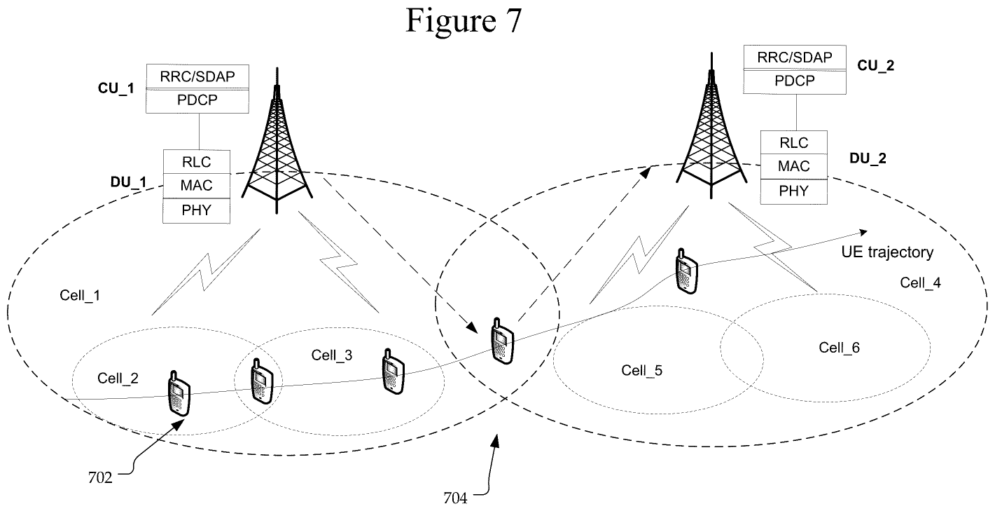

FIG. 6 shows an embodiment of user equipment (UE) intra-CU and inter-DU mobility. In this embodiment, the basestation may include a CU and two DUs (DU_1 and DU_2). Although each DU may have multiple cells, for this example each DU is shown providing a single cell such that DU_1 is providing Cell 1 and DU_2 is providing Cell 2. In this example, the UE 602 can move from Cell 1 to Cell 2 and is depicted in FIG. 6 with a UE trajectory from Cell 1 to Cell 2 which also results in a transition from DU_1 to DU_2. The mobility from cells may occur when the UE 502 is in a position between the two cells and making its way to the third position within Cell 2. This is intra-CU mobility because the UE is moving cells within a single CU. However, this is also inter-DU mobility because the UE is moving between different DUs.

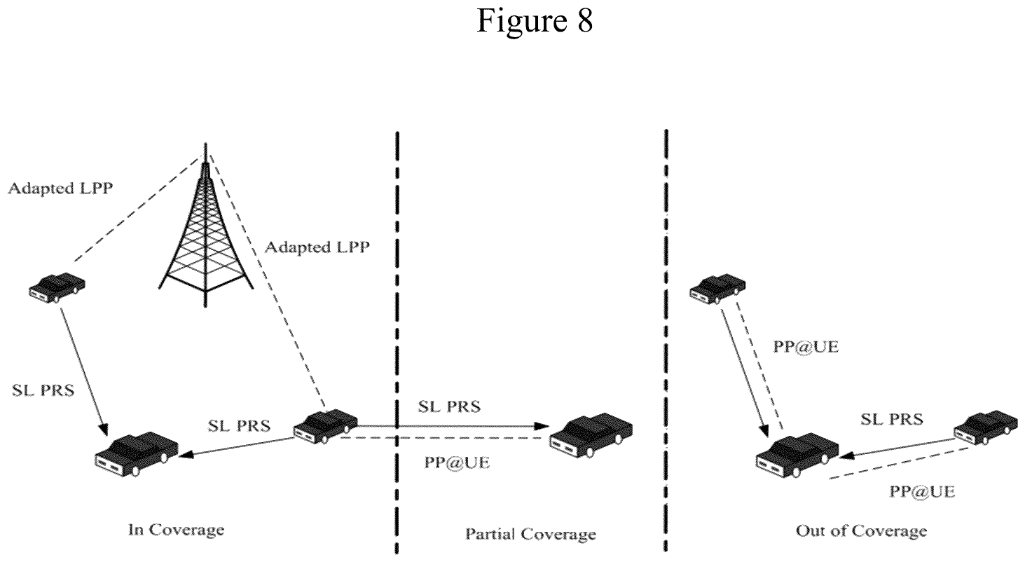

FIG. 7 shows an embodiment of user equipment (UE) inter-CU mobility. In this embodiment, the basestation may include multiple CUs (CU_1 and CU_2). Each CU may include multiple DUs, but in this example, each CU is shown as having one corresponding DU (CU_1 has DU_1 and CU_2 has DU_2). Each of the DUs is shown with multiple cells. In this example, the UE trajectory of the UE 702 passes from Cell_2 to Cell_3 to an inter-CU position 704 (between CU_1 and CU_2) to Cell_5 and Cell_6. As the UE moves, the mobility may change cells as shown and may transition between a number of cells. Because the UE 702 (at the inter-CU position 704) switches cells from CU_1 to CU_2, this transition is referred to as inter-CU mobility.

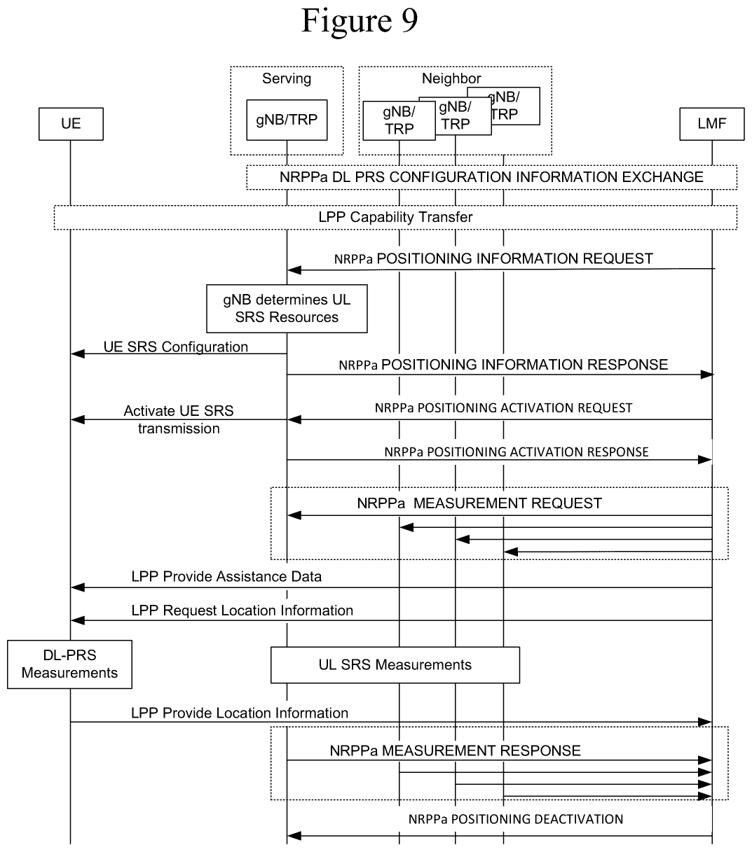

FIG. 8 shows an example of sidelink positioning coverage scenarios. FIG. 8 illustrates movement of a user equipment (UE), which is with a user in a vehicle in this example. The vehicle with the UE moves relative to the network node (i.e. adapted LTE positioning protocol (LPP)). As described herein, the network node may include a new radio (NR) node and a basestation is one example. For simplicity, the network node or NR node may be described as a basestation but may include other network nodes. There is a sidelink positioning reference signal (SL-PRS) signal from the network node to the UE while in coverage. As the UE moves out of coverage, there may be a PL-PRS from another UE. Out of coverage, the PL-PRS may come exclusively from another UE in a sidelink communication.

Positioning methods may include either uplink positioning or downlink positioning. In order to get higher accuracy positioning requirements, the network node (e.g. NG-RAN node or basestation) may assist in collecting required measurements. Example measurements include angle of arrival (AoA), a relative of time arrival (ROTA), etc. In order to enable location service (LCS) to satisfy the scenarios shown in FIG. 8 (e.g, in-coverage, partial coverage, and out-of-coverage) sidelink positioning may be utilized. The sidelink positioning reference signal (SL-PRS) may be a part of the new radio (NR) sidelink positioning system. In one embodiment, a Location Management Function (LMF) request may be made to the network node with sidelink (SL) positioning information. As discussed below, the SL positioning information may include a SL-PRS configuration, or a SL communication resource for the UE. As described, the LMF may request the network node to configure or update the SL positioning information. The network node may acknowledge the status of SL positioning resources for a sidelink positioning operation.

FIG. 9 shows an example of a positioning procedure. In this example, the serving network node and the neighboring network node(s) may include a basestation (e.g. gNB) or a Transmission/Reception Point (TRP), each of which can communicate with a Location Management Function (LMF) and/or a user equipment (UE). FIG. 9 is merely one example of a positioning procedure and illustrates example communications between the user equipment (UE), a serving network node, neighbor network node(s), and an LMF. In this example, multiple neighboring basestations are shown, but there could be more or fewer neighbors in some examples. The communications are also with the Location Management Function (LMF). In this example, the communications are with new radio (NR) Positioning Protocol A (NRPPa).

In FIG. 9, this example procedure shows one example of how the LMF may obtain the Transmission/Reception Point (TRP) information required for multiple round-trip time (multi-RTT) positioning to exchange the DL-PRS configuration. The LMF sends the NRPPa POSITIONING INFORMATION PROCEDURE to the serving network node/basestation to request uplink (UL) information for the target device for the uplink sounding reference signal (UL-SRS) configuration. For the SL positioning, the SL-PRS configuration and the SL communication resources are also needed to exchange between the network (NG-RAN) node and the LMF.

### TRP Information Procedure Between Network Node and LMF

FIG. 10 shows a Transmission/Reception Point (TRP) information exchange procedure. The TRP information exchange procedure in FIG. 10 is between a network node (i.e. NG-RAN node or basestation) and the location management function (LMF). The TRP information exchange procedure allows the LMF to request the network node to provide detailed information for TRPs hosted by the network node. The procedure includes a TRP Information Request from the LMF to the network node and a TRP Information Response from the network node to the LMF.

The TRP Information Request is a message from the LMF to the network node requesting SL information for TRPs hosted by a network node. For the sidelink positioning, the message includes a request for SL information, such as a sidelink positioning reference signal (SL-PRS) configuration, and/or a SL resource configuration. The SL information including the SL-PRS configuration and/or the SL resource configuration are further described below. The request message may be referred to as a request for configuration. The following table illustrates an example information element (IE) for the TRP Information Request:

TABLE 1
TRP Information Request IE Message.

| | | | | | | |
|---|---|---|---|---|---|---|
| | | | | Semantics | | Assigned |
| IE/Group Name | Presence | Range | IE type and reference | desc. | Criticality | Criticality |

| | | | | | |
|---|---|---|---|---|---|
| Message Type | M | | 9.2.3 | YES | reject |
| NRPPa Transaction ID | M | | 9.2.4 | — | |
| TRP List | | 0 . . . 1 | | YES | ignore |
| >TRP Item | | 1 . . . | | EACH | ignore |
| | | <maxnoTRPs> | | | |
| >>TRP ID | M | | 9.2.24 | — | |
| TRP Information | | 1 | | | |
| Type List | | | | | |
| >TRP Information | | 1 . . . | | EACH | reject |
| Type Item | | <maxnoTRPInfoTypes> | | | |
| >>TRP Information | M | | ENUMERATED (nr | | |
| Type Item | | | pci, ng-ran cgi, nr arfcn, | | |
| | | | prs config, ssb config, | | |
| | | | sfn init time, spatial | | |
| | | | direction info, geo- | | |
| | | | coordinates, . . . , trp type, | | |
| | | | on-demand trp prs info, | | |
| | | | trp tx teg, beam antenna | | |
| | | | info, sl-prs config, sl- | | |
| | | | resource config) | | |

As illustrated in Table 1, the TRP Information Type Item may include SL-PRS configuration and SL resource configuration. FIG. 10 illustrates including this SL information in the TRP Information Request. In other words, TRP Information is modified to include SL information.

The TRP Information Response is a message from the network node to the LMF with the requested SL information for TRPs hosted by a network node. For the sidelink positioning, the message includes SL information, such as a sidelink positioning reference signal (SL-PRS) configuration, and/or a SL resource configuration. The SL information including the SL-PRS configuration and/or the SL resource configuration are further described below. The response message may include the requested TRP information that includes the SL information as shown in Table 1.

In one embodiment (not shown in FIG. 10), if the network node cannot provide the requested information, then the network node may respond with a failure message. The message may be a TRP Information Failure message to let the LMF know that the network node does not have the requested information.

The TRP Information Response is a message from the network node to the LMF with the requested SL information for TRPs hosted by a network node. For the sidelink positioning, the message includes SL information, such as a sidelink positioning reference signal (SL-PRS) configuration, and/or a SL resource configuration. The response message may include the requested TRP information that includes the SL information as shown in Table 1. The following table illustrates an example information element (IE) for a the TRP Information Response:

TABLE 3
TRP Information Response IE Message.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | | 9.2.3 | YES | reject |
| NRPPa Transaction ID | M | | 9.2.4 | — | |
| TRP Information List | | 1 | | YES | ignore |
| >TRP Information | M | 1 . . . | | EACH | ignore |
| Item | | <maxnoTRPs> | | | |
| >>TRP Information | M | | 9.2.25 | — | |
| Criticality Diagnostics | O | | 9.2.2 | YES | ignore |

FIG. 10 illustrates including SL information within TRP information. The TRP information is shown in the following example information element (IE):

TABLE 4
TRP Information IE.

| | | | IE Type and | Semantics | | Assigned |
|---|---|---|---|---|---|---|
| IE/Group Name | Presence | Range | Reference | Description | Criticality | Criticality |
| TRP ID | M | | 9.2.24 | | — | |
| TRP Information Type | | 1 . . . | | | — | |
| | | <maxnoTRPInfoTypes> | | | | |
| >CHOICE TRP | M | | | | — | |
| Information Item | | | | | | |
| >>NR PCI | M | | INTEGER | NR Physical | — | |
| | | | (0 . . . 1007) | Cell ID | | |
| >>NR CGI | M | | 9.2.9 | | — | |
| >>NR ARFCN | M | | INTEGER | | — | |
| | | | (0 . . . 3279165) | | | |
| >>PRS | M | | 9.2.44 | | — | |
| Configuration | | | | | | |
| >>SSB Information | M | | 9.2.54 | | — | |
| >>SFN Initialisation | M | | Relative Time | | — | |
| Time | | | 1900 | | | |
| | | | 9.2.36 | | | |
| >>Spatial Direction | M | | 9.2.45 | | — | |
| Information | | | | | | |
| >>Geographical | M | | 9.2.46 | | — | |
| Coordinates | | | | | | |
| >>TRP type | M | | ENUMERATED | TS 38.305 | YES | reject |
| | | | (prs-only-tp, | [18] | | |
| | | | srs-only-rp, tp, | | | |
| | | | rp, trp . . . ) | | | |
| >>On-demand PRS | M | | 9.2.65 | | YES | reject |
| TRP Information | | | | | | |
| >>TRP Tx TEG | M | | 9.2.79 | | YES | reject |
| Association | | | | | | |
| >>TRP Beam | M | | 9.2.82 | | YES | reject |
| Antenna | | | | | | |
| Information | | | | | | |
| >>SL-PRS | | | 9.2.xx | | | |
| Configuration | | | | | | |
| >>SL Resource | | | 9.2.yy | | | |
| Configuration | | | | | | |

The TRP information may include a range bound as shown in the following table:

TABLE 5
TRP Information Range Bound.

| Range bound | Explanation |
|---|---|
| maxnoTRPInfoTypes | Maximum no of TRP information |
| | types that can be requested and |
| | reported with one message. Value is 64. |

As described, the SL information may include SL-PRS configuration or SL resource configuration. Examples of SL-PRS configuration may include:
SL-PRS Resource Set ID;
Subcarrier spacing;
SL-PRS bandwidth;
New radio (NR) absolute radio-frequency channel number (ARFCN);
Comb Size;
Resource Set Periodicity;
Resource Repetition Factor;
Resource Time Gap;
Resource Number of Symbols;
SL-PRS Muting Pattern;
Resource Transmit Power;
SL-PRS Resource ID;
Quasi-Colocation (QCL) Information per SL-PRS;
Resource Slot Offset; or
Resource Symbol Offset.

An example information element (IE) including the SL-PRS configuration is shown in the following table:

TABLE 6
SL-PRS Configuration IE.

| | | | IE | Semantics |
|---|---|---|---|---|
| | Pre- | | Type and | Des- |
| JE/Group Name | sence | Range | Reference | cription |
| SL-PRS Resource Set List | | | | |
| >SL-PRS Resource Set Item | | | | |
| >>SL- PRS Resource Set ID | | | | |
| >>Subcarrier Spacing | | | | |
| >>SL-PRS bandwidth | | | | |
| >>NR ARFCN | | | | |
| >>Comb Size | | | | |
| >>Resource Set Periodicity | | | | |
| >>Resource Repetition Factor | | | | |
| >>Resource Time Gap | | | | |
| >>Resource Number of Symbols | | | | |
| >>SL-PRS Muting Pattern | | | | |
| >>SL-PRS Transmit Power | | | | |
| >>SL-PRS Resource List | | | | |
| >>>SL-PRS Resource Item | | | | |
| >>>>SL-PRS Resource ID | | | | |
| >>>>QCL Information | | | | |
| >>>>Resource Slot Offset | | | | |
| >>>>Resource Symbol Offset | | | | |

The SL information may further include SL resource configuration, which may include:
Resource Block (RB) number, which indicates the number of Physical Resource Blocks (PRBs) in the corresponding resource pool;
Start RB sub channel, which indicates the lowest RB index of the subchannel with the lowest index in the resource pool;
Subchannel Size, which indicates the minimum granularity in frequency domain;
Time Resource, which indicates the bitmap of the resource pool;
Time offset, which indicates the timing offset of the UE; or
Synchronization Signal Block (SSB) Priority, which indicates the priority of NR sidelink SSB transmission and reception.

An example information element (IE) including the SL resource configuration is shown in the following table:

TABLE 7
SL Resource Configuration IE.

| | | | IE Type and | Semantics |
|---|---|---|---|---|
| IE/Group Name | Presence | Range | Reference | Description |
| RB number | | | | |
| Start RB sub-channel | | | | |
| Sub-channel Size | | | | |
| Time Resource | | | | |
| Time Offset | | | | |
| SSB Priority | | | | |

### SL-PRS Positioning Configuration Procedure Between NG-RAN and LMF

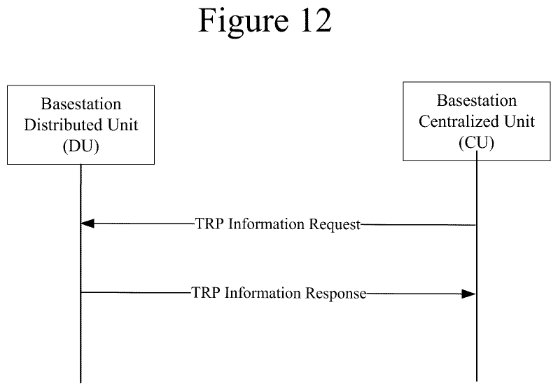

FIG. 11 shows a sidelink positioning reference signal (SL-PRS) positioning configuration procedure. The SL-PRS positioning configuration exchange procedure in FIG. 11 is between a network node (i.e. NG-RAN node or basestation) and the location management function (LMF). The procedure is initiated by the LMF to request the network node to configure or update an SL-PRS transmission. The SL-PRS positioning configuration procedure allows the LMF to request the network node to provide detailed positioning information. The procedure includes a SL-PRS positioning configuration request from the LMF to the network node and a SL-PRS positioning configuration response from the network node to the LMF.

The procedure in FIG. 11 may be a modified version of communication messages between the LMF and the network node. FIG. 10 illustrated including SL information within TRP information messages, but FIG. 11 illustrates a different type of communication messages that are referred to as SL-PRS Configuration messaging. In other embodiments, the request/response may be a Positioning Information request and a Positioning Information response that includes positioning information. The positioning information requested and sent with the response may include positioning information for the UE.

The SL-PRS Configuration Request is a message from the LMF to the network node requesting SL information from the network node. For the sidelink positioning, the message includes a request for SL information, such as a sidelink positioning reference signal (SL-PRS) configuration, and/or a SL resource configuration. The request message may be referred to as a request for configuration. The following table illustrates an example information element (IE) for the SL-PRS Configuration Request:

TABLE 8
SL-PRS Configuration Request IE.

| | | | | | | |
|---|---|---|---|---|---|---|
| | | | IE type and | Semantics | | Assigned |
| IE/Group Name | Presence | Range | reference | description | Criticality | Criticality |

Message Type
NRPPa Transaction ID
Requested SL-PRS
Transmission
Characteristics
Requested SL resource
configuration

The network node may receive the SL-PRS Configuration Request and configures the requested information. The network node can respond with the SL-PRS Configuration Response which may include the SL information or the requested configuration. The SL-PRS Configuration Response is a message from the network node to the LMF with the requested SL information. The response may acknowledge configuring or updating the SL-PRS transmission based on the requested information by the LMF, and also responds with the configuration information to LMF in the response message.

For the sidelink positioning, the message includes SL information, such as a sidelink positioning reference signal (SL-PRS) configuration, and/or a SL resource configuration. The response message may be referred to as a response to the request for configuration that acknowledges configuring or updating the PRS transmission. The following table illustrates an example information element (IE) for the SL-PRS Configuration Response:

TABLE 9
SL-PRS Configuration Response IE.

| | | | | | | |
|---|---|---|---|---|---|---|
| | | | IE type/ | Semantics | | Assigned |
| IE/Group Name | Presence | Range | reference | description | Criticality | Criticality |

| | |
|---|---|
| Message Type | |
| NRPPa Transaction ID | — |
| SL-PRS Configuration | — |
| SL-Resource Configuration | |

In one embodiment (not shown in FIG. 11), if the network node cannot provide the requested information, then the network node may respond with a failure message. The message may be a SL-PRS Configuration Failure message to let the LMF know that the network node does not have the requested information.

As described, the SL information may include SL-PRS configuration or SL resource configuration. Examples of SL-PRS configuration may include:
SL-PRS Resource Set ID;
Subcarrier spacing;
SL-PRS bandwidth;
New radio (NR) absolute radio-frequency channel number (ARFCN);
Comb Size;
Resource Set Periodicity;
Resource Repetition Factor;
Resource Time Gap;
Resource Number of Symbols;
SL-PRS Muting Pattern;
SL-PRS Resource Transmit Power;
SL-PRS Resource ID;
Quasi-Colocation (QCL) Information per SL-PRS;
Resource Slot Offset; or
Resource Symbol Offset.

One example information element (IE) including the SL-PRS configuration is shown in Table 6.

The SL information may further include SL resource configuration, which may include:
Resource Block (RB) number, which indicates the number of Physical Resource Blocks (PRBs) in the corresponding resource pool;
Start RB sub channel, which indicates the lowest RB index of the subchannel with the lowest index in the resource pool;
Subchannel Size, which indicates the minimum granularity in frequency domain;
Time Resource, which indicates the bitmap of the resource pool;
Time offset, which indicates the timing offset of the UE; or
Synchronization Signal Block (SSB) Priority, which indicates the priority of NR sidelink SSB transmission and reception.

One example information element (IE) including the SL resource configuration is shown in Table 7.

### TRP Information Procedure Between Centralized Unit (CU) and Distributed Unit (DU)

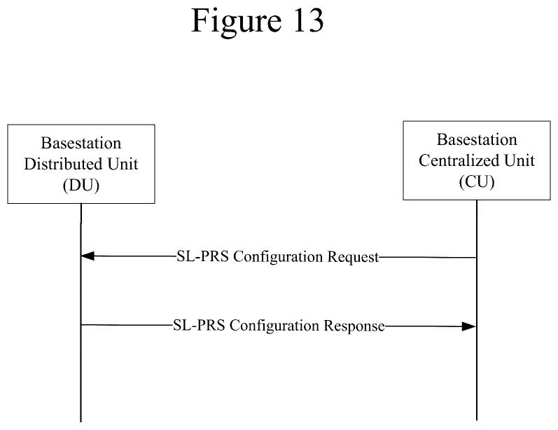

FIG. 12 shows another Transmission/Reception Point (TRP) information exchange procedure. The TRP information exchange procedure in FIG. 12 is between a network node or basestation distributed unit (DU) and a network node or basestation centralized unit (CU). The DU and CU are further described above with respect to FIG. 3-4. The TRP information exchange procedure allows the CU to request the DU to provide detailed information for TRPs hosted by the network node. The procedure includes a TRP Information Request from the CU to the DU and a TRP Information Response from the DU to the CU.

The TRP Information Request is a message from the DU to the CU requesting SL information for TRPs hosted by a network node. For the sidelink positioning, the message includes a request SL information, such as a sidelink positioning reference signal (SL-PRS) configuration, and/or a SL resource configuration. The SL information including the SL-PRS configuration and/or the SL resource configuration are further described below. The request message may be referred to as a request for configuration. Table 1 above illustrates an example information element (IE) for a the TRP Information Request. As illustrated in Table 1, the TRP Information Type Item may include SL-PRS configuration and SL resource configuration. FIG. 12 illustrates including this SL information in the TRP Information Request. In other words, TRP Information is modified to include SL information.

The TRP Information Response is a message from the DU to the CU with the requested SL information for TRPs hosted by a network node. For the sidelink positioning, the message includes SL information, such as a sidelink positioning reference signal (SL-PRS) configuration, and/or a SL resource configuration. The response message may include the requested TRP information that includes the SL information as shown in Table 1. In one embodiment (not shown in FIG. 12), if the DU cannot provide the requested information, then the DU may respond with a failure message to let the CU know that the DU does not have the requested information.

The TRP Information Response is a message from the CU to the DU with the requested SL information. For the sidelink positioning, the message includes SL information, such as a sidelink positioning reference signal (SL-PRS) configuration, and/or a SL resource configuration. The response message may include the requested SL information as shown in Table 1. Table 3 illustrated an example information element (IE) for the TRP Information Response. FIG. 12 illustrates including SL information within TRP information. The TRP information is shown in the following example information element (IE) from Table 4.

As described, the SL information may include SL-PRS configuration or SL resource configuration. Examples of SL-PRS configuration may include:
SL-PRS Resource Set ID;
Subcarrier spacing;
SL-PRS bandwidth;
New radio (NR) absolute radio-frequency channel number (ARFCN);
Comb Size;
Resource Set Periodicity;
Resource Repetition Factor;
Resource Time Gap;
Resource Number of Symbols;
SL-PRS Muting Pattern;
SL-PRS Resource Transmit Power;
SL-PRS Resource ID;
Quasi-Colocation (QCL) Information per SL-PRS;
Resource Slot Offset; or
Resource Symbol Offset.

One example information element (IE) including the SL-PRS configuration is shown in Table 6.

The SL information may further include SL resource configuration, which may include:
Resource Block (RB) number, which indicates the number of Physical Resource Blocks (PRBs) in the corresponding resource pool;
Start RB sub channel, which indicates the lowest RB index of the subchannel with the lowest index in the resource pool;
Subchannel Size, which indicates the minimum granularity in frequency domain;
Time Resource, which indicates the bitmap of the resource pool;
Time offset, which indicates the timing offset of the UE; or
Synchronization Signal Block (SSB) Priority, which indicates the priority of NR sidelink SSB transmission and reception.

One example information element (IE) including the SL resource configuration is shown in Table 7.

### SL-PRS Positioning Configuration Between Centralized Unit (CU) and Distributed Unit (DU)

FIG. 13 shows another sidelink positioning reference signal (SL-PRS) positioning configuration procedure. The SL-PRS positioning configuration exchange procedure in FIG. 13 is between a network node or basestation distributed unit (DU) and a network node or basestation centralized unit (CU). The configuration procedure may be initiated by the CU to request the DU to configure or update a SL-PRS transmission. The configuration procedure allows the CU to request the DU to provide detailed positioning information. The procedure includes a SL-PRS positioning configuration request from the CU to the DU and a SL-PRS positioning configuration response from the DU to the CU.

The procedure in FIG. 13 may be a modified version of communication messages between the distributed unit (DU) and the centralized unit (CU). Conversely, FIG. 12 illustrated including SL information within TRP information messages, but FIG. 13 illustrates a different type of communication messages that are referred to as SL-PRS Configuration messaging. In other embodiments, the request/response may be a Positioning Information request and a Positioning Information response that includes positioning information. The positioning information requested and sent with the response may include positioning information for the UE.

The SL-PRS Configuration Request is a message from the DU to the CU requesting SL information from the DU. For the sidelink positioning, the message includes a request for SL information, such as a sidelink positioning reference signal (SL-PRS) configuration, and/or a SL resource configuration. The request message may be referred to as a request for configuration. An example information element (IE) for the SL-PRS Configuration Request is shown in Table 8.

The DU may receive the SL-PRS Configuration Request and configures the requested information. The DU can respond with the SL-PRS Configuration Response which may include the SL information or the requested configuration. The SL-PRS Configuration Response is a message from the DU to the CU with the requested SL information. The response may acknowledge configuring or updating the SL-PRS transmission based on the requested information by the CU, and also responds with the configuration information to the CU in the response message.

For the sidelink positioning, the message includes SL information, such as a sidelink positioning reference signal (SL-PRS) configuration, and/or a SL resource configuration. The response message may be referred to as a response to the request for configuration that acknowledges configuring or updating the PRS transmission. An example information element (IE) for the SL-PRS Configuration Response is shown in Table 9. In one embodiment (not shown in FIG. 13), if the DU cannot provide the requested information, then the DU may respond with a failure message. The message may be a SL-PRS Configuration Failure message to let the CU know that the DU does not have the requested information.

As described, the SL information may include SL-PRS configuration or SL resource configuration. Examples of SL-PRS configuration may include:
SL-PRS Resource Set ID;
Subcarrier spacing;
SL-PRS bandwidth;
New radio (NR) absolute radio-frequency channel number (ARFCN);
Comb Size;
Resource Set Periodicity;
Resource Repetition Factor;
Resource Time Gap;
Resource Number of Symbols;
SL-PRS Muting Pattern;
SL-PRS Resource Transmit Power;
SL-PRS Resource ID;
Quasi-Colocation (QCL) Information per SL-PRS;
Resource Slot Offset; or
Resource Symbol Offset.

One example information element (IE) including the SL-PRS configuration is shown in Table 6.

The SL information may further include SL resource configuration, which may include:
Resource Block (RB) number, which indicates the number of Physical Resource Blocks (PRBs) in the corresponding resource pool;
Start RB sub channel, which indicates the lowest RB index of the subchannel with the lowest index in the resource pool;
Subchannel Size, which indicates the minimum granularity in frequency domain;
Time Resource, which indicates the bitmap of the resource pool;
Time offset, which indicates the timing offset of the UE; or
Synchronization Signal Block (SSB) Priority, which indicates the priority of NR sidelink SSB transmission and reception.

One example information element (IE) including the SL resource configuration is shown in Table 7.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication comprising:
receiving, by a basestation from a location management function (LMF) or by a basestation distributed unit (DU) from a basestation centralized unit (CU), a Transmission/Reception Point (TRP) request message with a request for sidelink configuration information or a Sidelink Positioning Reference Signal (SL-PRS) request message with a sidelink configuration information; and
transmitting, from the basestation to the LMF or from the basestation DU to the basestation CU, a TRP response message with the sidelink configuration information or an SL-PRS response message with the sidelink configuration information.

2-3. (canceled)

4. The method of claim 1, wherein the sidelink configuration information comprises a sidelink positioning reference signal (SL-PRS) configuration or a sidelink resource configuration.

5. The method of claim 4, wherein the SL-PRS configuration comprises at least one of a SL-PRS Resource Set ID, a Subcarrier spacing, a SL-PRS bandwidth, an absolute radio frequency channel number (ARFCN), a Comb Size, a Resource Set Periodicity, a Resource Repetition Factor, a Resource Time Gap, a Resource Number of Symbols, a SL-PRS Muting Pattern, a SL-PRS Resource Transmit Power, a SL-PRS Resource ID, a Quasi Colocation (QCL) Information per SL-PRS, a Resource Slot Offset, or a Resource Symbol Offset.

6. The method of claim 4, wherein the sidelink resource configuration comprises at least one of a resource block (RB) number, an RB sub channel, a subchannel size, a time resource, a time offset, or a synchronization signal block (SSB) priority.

7. The method of claim 4, wherein the TRP request message includes a TRP type information element that includes a request for at least one of the SL-PRS configuration or the sidelink resource configuration.

8. The method of claim 4, wherein the TRP response message comprises TRP information that includes at least one of the SL-PRS configuration or the sidelink resource configuration.

9. The method of claim 1, further comprising:
transmitting a TRP fail message or an SL-PRS fail message when the sidelink configuration information is not available for transmission.

10. A method for wireless communication comprising:
sending, by a location management function (LMF) to a basestation or by a basestation centralized unit (CU) to a basestation distributed unit (DU), a Transmission/Reception Point (TRP) request message with a request for sidelink configuration information or a Sidelink Positioning Reference Signal (SL-PRS) request message with a request for sidelink configuration information; and
receiving, at the LMF from the basestation or at the basestation CU from the basestation DU, a TRP response message with the sidelink configuration information or an SL-PRS response message with the sidelink configuration information.

11-12. (canceled)

13. The method of claim 10, wherein the sidelink configuration information comprises a sidelink positioning reference signal (SL-PRS) configuration or a sidelink resource configuration.

14. The method of claim 13, wherein the SL-PRS configuration comprises at least one of a SL-PRS Resource Set ID, a Subcarrier spacing, a SL-PRS bandwidth, an absolute radio frequency channel number (ARFCN), a Comb Size, a Resource Set Periodicity, a Resource Repetition Factor, a Resource Time Gap, a Resource Number of Symbols, a SL-PRS Muting Pattern, a SL-PRS Resource Transmit Power, a SL-PRS Resource ID, a Quasi Colocation (QCL) Information per SL-PRS, a Resource Slot Offset, or a Resource Symbol Offset.

15. The method of claim 13, wherein the sidelink resource configuration comprises at least one of a resource block (RB) number, an RB sub channel, a subchannel size, a time resource, a time offset, or a synchronization signal block (SSB) priority.

16. The method of claim 13, wherein the TRP request message includes a TRP type information element that includes a request for at least one of the SL-PRS configuration or the sidelink resource configuration.

17. The method of claim 13, wherein the TRP response message comprises TRP information that includes at least one of the SL-PRS configuration or the sidelink resource configuration.

18. The method of claim 10, further comprising:
receiving a TRP fail message or an SL-PRS fail message when the sidelink configuration information is not available for transmission.

19-24. (canceled)

25. The method of claim 1, wherein the SL-PRS request message includes an SL-PRS information element (IE) that includes a request for at least one of the SL-PRS configuration or a sidelink resource configuration; and the SL-PRS response message comprises an SL-PRS IE that includes at least one of the sidelink positioning reference signal (SL-PRS) configuration or the sidelink resource configuration.

26-33. (canceled)

34. The method of claim 10, wherein the SL-PRS request message includes an SL-PRS information element (IE) that includes a request for at least one of the sidelink positioning reference signal (SL-PRS) configuration or a sidelink resource configuration; and the SL-PRS response message comprises an SL-PRS IE that includes at least one of the SL-PRS configuration or the sidelink resource configuration.

35-36. (canceled)

37. A wireless communications apparatus comprising a processor and a memory, wherein the processor is configured to read code from the memory and implement the method recited in claim 1.

38. A computer program product comprising a computer-readable program medium code stored thereupon, the code, when executed by a processor, causing the processor to implement the method recited in any of claim 1.

39. A wireless communications apparatus comprising a processor and a memory, wherein the processor is configured to read code from the memory and implement the method recited in claim 10.

40. A computer program product comprising a computer-readable program medium code stored thereupon, the code, when executed by a processor, causing the processor to implement the method recited in claim 10.
